(19) United States
(12) Patent Application Publication
(10) Pub. No.: US 2024/0326577 A1
(43) Pub. Date: Oct. 3, 2024

(54) Agricultural Working Tool

(71) Applicant: CLAAS Saulgau GmbH, 88348 Bad Saulgau (DE)

(72) Inventors: Martin Ober, D-78736 Trichtingen (DE); Dominik Eisele, Mengen-Beuren (DE)

(21) Appl. No.: 18/612,404

(22) Filed: Mar. 21, 2024

(30) Foreign Application Priority Data
Mar. 31, 2023 (DE) 102023108337.6

(51) Int. Cl. B60K 11/02

(52) U.S. Cl. CPC B60K 11/02; B60Y 2200/22

(57) ABSTRACT

Agricultural working tool (10) which is constructed for coupling to an agricultural carrier vehicle (11) or towing vehicle, having at least one hydraulic power take-off member (27), having hydraulic connections (15), via which the at least one hydraulic power take-off member (27) can be supplied with hydraulic oil from the carrier vehicle (11) or towing vehicle, having a cooling system (16) for cooling the hydraulic oil, wherein at least oil-carrying sub-assemblies of the cooling system (16) are pressure-resistant up to at least 200 bar.

The invention relates to an agricultural working tool according to the preamble of claim 1.

Agricultural working tools, such as, for example, mowers, can be coupled to an agricultural carrier vehicle or towing vehicle, such as, for example, a tractor. An agricultural working tool has in this instance at least one hydraulic power take-off member, in particular a hydraulic drive, wherein the at least one hydraulic power take-off member can be supplied with hydraulic oil from the carrier vehicle or towing vehicle, that is to say, via hydraulic connections of the agricultural working tool which can be coupled to hydraulic connections of the carrier vehicle or towing vehicle.

It has been found that the hydraulic oil which is used in agricultural working tools to transmit drive energy often reaches an excessively high temperature, which can lead to overheating of the hydraulic oil. In order to avoid overheating of the hydraulic oil with an agricultural working tool, it is already known to install on the agricultural towing vehicle or carrier vehicle a more complex on-board hydraulic system. However, this leads to additional costs and additional weight and increased maintenance complexity.

In order to avoid overheating of the hydraulic oil in the region of the agricultural working tool and to dispense with a complex on-board hydraulic system on the agricultural carrier vehicle or towing vehicle, it is already known from EP 1 854 345 B1 that an agricultural working tool may have a cooling system. EP 1 854 345 B1 thus discloses a cooling system for a hydraulic drive of an agricultural working tool for cooling a hydraulic fluid. The thermal energy of the hydraulic fluid which is intended to be cooled is in this instance discharged to a flow of harvested material.

If the agricultural working tool has a cooling system which can be connected via the hydraulic connections of the agricultural working tool to the hydraulic connections of the agricultural carrier vehicle or towing vehicle, for example, as a result of an operating error or a malfunction, an excess pressure may occur in the cooling system so that the cooling system may burst. In this instance, hydraulic oil from the cooling system of the agricultural working tool can then run onto the road or the field.

There is a requirement for an agricultural working tool in which leakages in the region of the cooling system can be avoided and in which there is thus no risk of hydraulic oil running onto the road or the field, for example, as a result of bursting of the cooling system as a result of an operating error or a malfunction.

Based on this, an object of the present invention is to provide a new type of agricultural working tool.

This object is achieved with an agricultural working tool according to patent claim 1.

According to the invention, at least oil-carrying sub-assemblies of the cooling system are pressure-resistant up to at least 200 bar. It is thus possible to avoid the cooling system of the agricultural working tool bursting, for example, as a result of an operating error or a malfunction. There is no risk of hydraulic oil running onto the road or the field.

Preferably, the cooling system has a pipeline heat exchanger which is arranged in a coolant container and whose at least one pipeline through which oil flows is pressure-resistant up to at least 200 bar and whose at least one pipeline through which oil flows is flowed around by coolant which flows through the coolant container. This is particularly preferable in order, on the one hand, to provide an effective cooling of the oil in the region of the cooling system of the agricultural working tool and, on the other hand, to prevent, for example, an operating error or a malfunction leading to a defect on the cooling system.

Preferably, the at least one pipeline of the pipeline heat exchanger is constructed in a coil-like or helical manner. This enables a particularly effective cooling of the oil.

Preferably, there is provision for at least one supply for oil and at least one discharge for oil to extend through at least one wall of the coolant container, wherein via the at least one supply oil which is intended to be cooled can be supplied to the pipeline heat exchanger which is arranged in the coolant container and wherein via the at least one discharge oil which has been cooled by the pipeline heat exchanger which is arranged in the coolant container can be discharged. This enables a particularly effective cooling of the oil.

Preferably, the cooling system has a cooler for the coolant, wherein via an outgoing flow coolant can be removed from the coolant container and can be supplied to the cooler, and wherein via a return flow coolant from the cooler can be supplied to the coolant container. Via the cooler of the cooling system, the coolant which absorbs the thermal energy from the oil and which cools the oil can be effectively back-cooled with respect to the environment.

Preferred further developments of the invention will be appreciated from the dependent claims and the following description.

Exemplary embodiments of the invention will be explained in greater detail with reference to the drawings without being limited thereto. In the drawings:

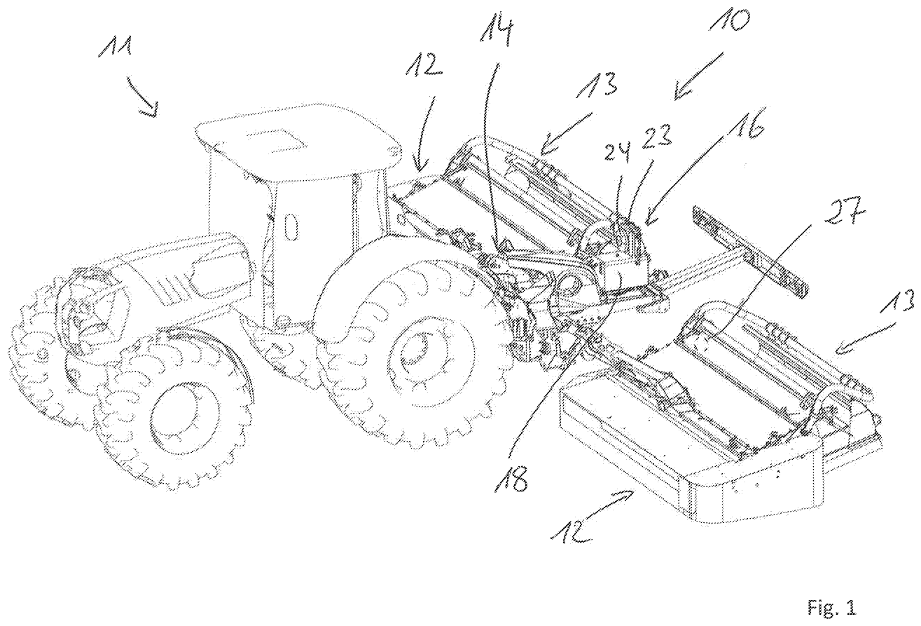

FIG. 1 shows a perspective view of an agricultural working tool together with an agricultural carrier vehicle or towing vehicle;

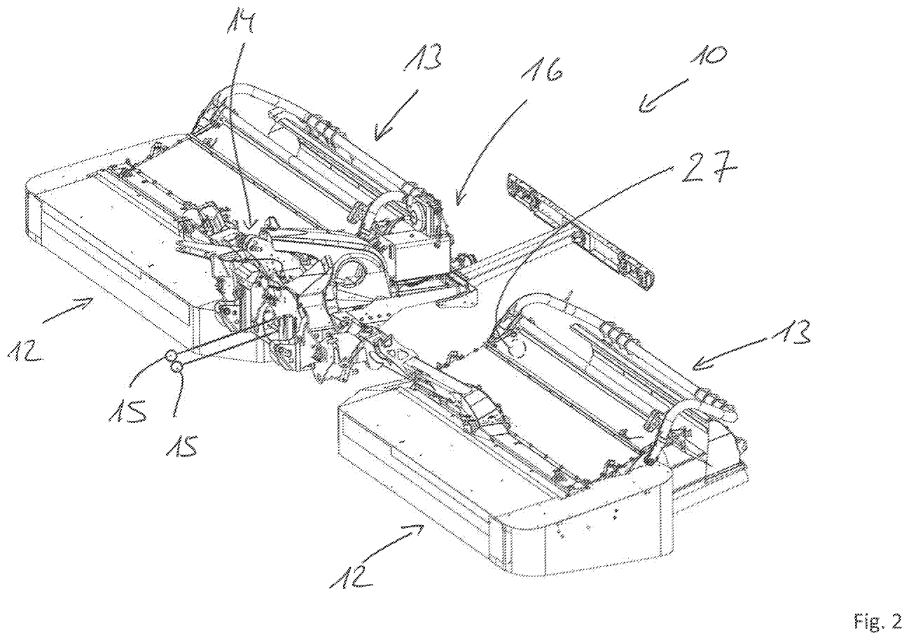

FIG. 2 shows a perspective view of the agricultural working tool; and

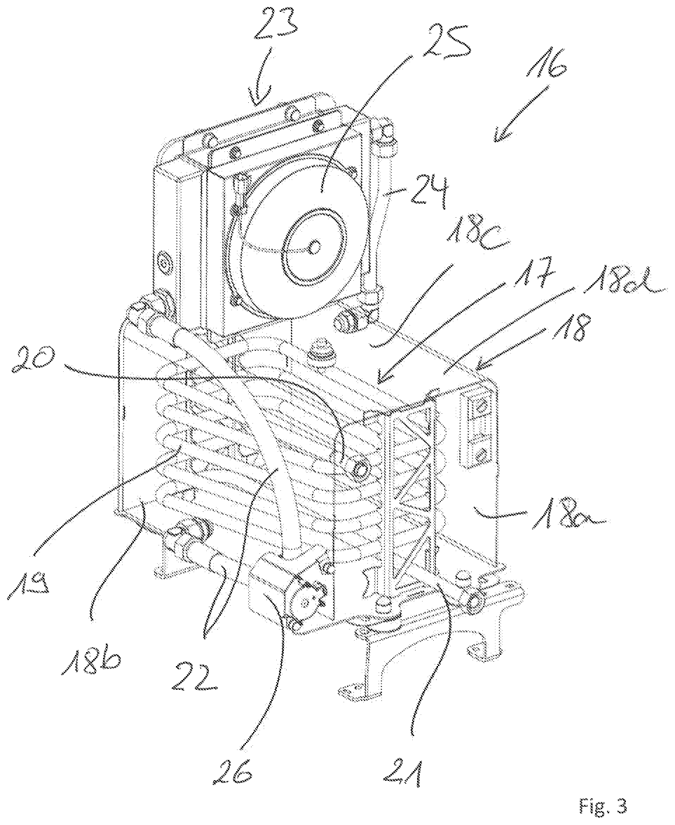

FIG. 3 shows a perspective view of a cooling system of the agricultural working tool.

FIG. 1 shows a perspective view of an agricultural working tool 10 which is in the form of a mower and which is coupled in FIG. 1 to an agricultural carrier vehicle 11 or agricultural towing vehicle. FIG. 2 shows the agricultural working tool 10 in a state illustrated alone.

In the exemplary embodiment shown, the agricultural working tool 10 which is in the form of a mower has two mowing units 12, wherein a cross-conveyor 13 which is in the form of a belt conveyor cooperates with each mowing unit 12. Harvested material, which is separated in the region of a mowing unit 12 from underlying ground which is intended to be processed reaches starting from the respective mowing unit 12 the region of the respective cross-conveyor 13 and is conveyed by the respective cross-conveyor 13 transversely relative to the travel direction of the agricultural carrier vehicle 11 preferably inward with a swath being formed. The cross-conveyors 13 have hydraulic power take-off members 27 which are in the form of hydraulic drives.

As already set out, the agricultural working tool, which is in the form of a mower in FIGS. 1 and 2, can be coupled to the agricultural carrier vehicle 11. FIGS. 1 and 2 thus show a trailer apparatus 14 via which the agricultural working tool 10 can be mechanically connected to the agricultural carrier vehicle 11.

FIG. 2 further shows hydraulic connections 15. Via the hydraulic connections 15, the agricultural working tool 10 can be coupled to a hydraulic system of the carrier vehicle 11 in order to be supplied with hydraulic oil from the carrier vehicle 11. This hydraulic oil is, for example, required by the hydraulic drives. The hydraulic drives of the cross-conveyors 13 are hydraulic power take-off members 27 of the agricultural working tool 10.

Already at this point, it should be noted that the invention can also be used in conjunction with other agricultural working tools. Hydraulic power take-off members which are supplied with hydraulic oil from the hydraulic system of the agricultural carrier vehicle 11 are also installed on other agricultural working tools.

The agricultural working tool 10 according to the invention which is a mower in FIGS. 1 and 2 has a cooling system 16 for cooling the hydraulic oil in order to avoid overheating of the hydraulic oil on the agricultural working tool 10. FIG. 3 shows the cooling system 16 in a state illustrated alone as a perspective view.

According to the invention, at least oil-carrying sub-assemblies of the cooling system 16 are pressure-resistant up to at least 200 bar. There is then no risk of a leakage occurring on the cooling system 16, for example, as a result of a malfunction or operating error, particularly when the hydraulic connections 15 of the agricultural working tool are incorrectly connected to corresponding hydraulic connections of the agricultural carrier vehicle 11. It is thus possible to avoid oil running in the direction toward the road or the field.

The cooling system 16 has a pipeline heat exchanger 17 which is arranged in a coolant container 18. The pipeline heat exchanger 17 has at least one pipeline 19 through which oil flows, wherein this pipeline 19, through which oil flows, of the pipeline heat exchanger 17 is pressure-resistant up to at least 200 bar. The at least one pipeline 19, through which oil flows, of the pipeline heat exchanger 17 is flowed through by oil and flowed around by coolant, wherein the coolant flows through the coolant container 18.

In FIG. 3, the shown pipeline 19 of the pipeline heat exchanger 17 is constructed in a helical manner. In the coolant container 18, a plurality of such helical pipelines 19 can be arranged one beside the other and can be connected in series or also in parallel with respect to each other.

The coolant container 18 in which the pipeline heat exchanger 17 is arranged has a plurality of walls. In FIG. 3, both a supply 20 for oil and a discharge 21 for oil extend through a wall 18a of the coolant container 18. Via the supply 20, oil which is intended to be cooled can be supplied to the pipeline heat exchanger 17 arranged in the coolant container 18. Cooled oil which has flowed through the pipeline heat exchanger 17 can be discharged from the pipeline heat exchanger 17 which is arranged in the coolant container 18 via the discharge 21.

Particularly when a plurality of pipeline heat exchangers 17 are arranged in a state connected in parallel with each other in the coolant container 18, a plurality of supplies 20 and a plurality of discharges 21 may extend through the wall 18a.

As already set out, coolant flows through the coolant container 18. On a wall 18b of the coolant container 18, there branches off an outgoing flow 22 via which coolant can be discharged from the coolant container 18 and guided in the direction toward a cooler 23. On an opposing wall 18c, a return flow 24 opens in the coolant container 18 in order to supply coolant from the cooler 23 to the coolant container 18. A coolant pump 28 is integrated in the outgoing flow 22 which extends between the coolant container 18 and the cooler 23.

The cooler 23 serves to cool the coolant which absorbs thermal energy from the oil in the region of the pipeline heat exchanger 17 with respect to ambient air in order to thus transfer the thermal energy absorbed by the coolant to the environment and to return cooled coolant into the coolant circuit, that is to say, in order to flow through the coolant container 18 and to flow around the pipeline heat exchanger 17 which is received in the coolant container 18. The cooler 23 is installed on a wall 18d of the coolant container 18.

The cooler 23 is in the form of an air heat exchanger which cools the coolant accordingly with respect to ambient air. In this instance, a fan 25 is associated with the cooler 23 in order to convey ambient air through the cooler 23 in order to cool the coolant.

The cooling system 16 of the agricultural working tool 10 according to the invention requires little structural space, and can therefore advantageously be installed on the agricultural working tool 10. It enables an effective cooling of the hydraulic oil and, as a result of the pressure-resistant configuration of oil-carrying sub-assemblies of the cooling system 16, prevents the cooling system 16 from bursting, for example, as a result of incorrect operation or a malfunction and oil thus from being able to reach the road or a field.

The cooling of the hydraulic oil is advantageously carried out in that the hydraulic oil flows through at least one pressure-resistant pipeline 19 of a pipeline heat exchanger 17, which is arranged in the coolant container 18, wherein the pipeline 19, through which oil flows, of the pipeline heat exchanger 17 is flowed around by coolant.

Coolant which flows around the at least one pipeline 19 of the pipeline heat exchanger 17 flows through the coolant container 18 and can be supplied from the coolant container 18 to the cooler 23 in order in the region of the cooler 23 to be back-cooled with respect to ambient air.

### List of reference numerals

10 Agricultural working tool
11 Agricultural carrier vehicle
12 Mowing unit
13 Cross-conveyor
14 Trailer apparatus
15 Hydraulic connection
16 Cooling system
17 Pipeline heat exchanger
18 Coolant container
18a Wall
18b Wall
18c Wall
18d Wall
19 Pipeline
20 Supply
21 Discharge
22 Outgoing flow
23 Cooler
24 Return flow
25 Fan
26 Coolant pump
27 Hydraulic power take-off member/drive

1. An agricultural working tool (10) which is constructed for coupling to an agricultural carrier vehicle (11) or towing vehicle, having at least one hydraulic power take-off member (27), having hydraulic connections (15), via which the at least one hydraulic power take-off member (27) can be supplied with hydraulic oil from the carrier vehicle (11) or towing vehicle, having a cooling system (16) for cooling the hydraulic oil, characterized in that at least oil-carrying sub-assemblies of the cooling system (16) are pressure-resistant up to at least 200 bar.

2. The agricultural working tool (10) according to claim 1, characterized in that the cooling system (16) has a pipeline heat exchanger (17) which is arranged in a coolant container (18) and whose at least one pipeline (19) through which oil flows is pressure-resistant up to at least 200 bar and whose at least one pipeline (19) through which oil flows is flowed around by coolant which flows through the coolant container (18).

3. The agricultural working tool (10) according to claim 1, characterized in that the at least one pipeline (19) of the pipeline heat exchanger (17) is constructed in a coil-like or helical manner.

4. The agricultural working tool (10) according to claim 1, characterized in that at least one supply (20) for oil and at least one discharge (21) for oil extends through at least one wall (18a) of the coolant container (18), via the at least one supply (20) oil which is intended to be cooled can be supplied to the pipeline heat exchanger (17) which is arranged in the coolant container (18), via the at least one discharge (21) oil which has been cooled by the pipeline heat exchanger (17) which is arranged in the coolant container (18) can be discharged.

5. The agricultural working tool (10) according to claim 1, characterized in that the cooling system has a cooler (23) for the coolant, wherein via an outgoing flow (22) coolant can be removed from the coolant container (18) and can be supplied to the cooler (23), and wherein via a return flow (24) coolant from the cooler (23) can be supplied to the coolant container (18).

6. The agricultural working tool (10) according to claim 5, characterized in that the cooler (23) is an air heat exchanger which cools the coolant with respect to ambient air.

7. The agricultural working tool (10) according to claim 5, characterized in that a fan (25) which conveys ambient air through the cooler (23) is associated with the cooler (23).

8. The agricultural working tool (10) according to claim 1, characterized in that a coolant pump (26) is integrated in the outgoing flow (22) which extends between the coolant container (18) and the cooler (23).

9. The agricultural working tool (10) according to claim 5, characterized in that the cooler (23) is mounted on a wall of the coolant container (18).

10. The agricultural working tool (10) according to claim 1, characterized in that the tool is a mower having at least one cross-conveyor (13) in the form of a belt conveyor for mown harvested material, wherein the respective cross-conveyor (13) has a hydraulic drive as a hydraulic power take-off member (27).
